(19) United States
(12) Patent Application Publication
(10) Pub. No.: US 2008/0163062 A1
(43) Pub. Date: Jul. 3, 2008

(54) USER INTERFACE METHOD AND APPARATUS

(75) Inventors: Joo-yeon Lee, Seoul (KR); Yoon-hark Oh, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/965,088

(22) Filed: Dec. 27, 2007

(30) Foreign Application Priority Data
Dec. 29, 2006 (KR) 2006-137967
Sep. 4, 2007 (KR) 2007-89574

(51) Int. Cl. G06F 3/16; G06F 3/048

(52) U.S. Cl. 715/727

(57) ABSTRACT

A user interface method and apparatus includes determining whether a command for user interface (UI) event occurrence is input, reading a pre-stored auditory user interface (AUI) element if the command for UI event occurrence is input is determined, generating an AUI based on the AUI element, and outputting the generated AUI to an outside. According to the method, an AUI environment using sound information is given to a user. Accordingly, the user can be guided to efficiently achieve a given task and reduce errors.

### CROSS-REFERENCE TO RELATED APPLICATIONS

This application claims priority under 35 U.S.C. §119 from Korean Patent Application Nos. 2006-0137967, and 2007-0089574, filed Dec. 29, 2006, and Sep. 4, 2007 in the Korean Intellectual Property Office, the entire disclosures of which are incorporated herein in their entirety by reference.

### BACKGROUND OF THE INVENTION

1. Field of the Invention

The present general inventive concept relates to a user interface method and an electronic device adopting the same. More particularly, the present general inventive concept relates to an auditory user interface (AUI) method using sound information and an electronic device adopting the same.

2. Description of the Related Art

Typically, AUI technology provides feedback by sound for various types of functions being performed in compliance with a user's demand in an electronic device and tasks occurring in the electronic device. Accordingly, a user is enabled to clearly recognize a situation and a state of task performance selected by the user.

An AUI processing device typically includes a key input unit, a digital signal processing unit, an AUI database, and a control unit for controlling an operation of the AUI processing device.

The AUI database includes sounds designated by a developer.

The control unit reads out a specified AUI sound corresponding to a user command from the AUI database, and provides the read AUI sound to the digital signal processing unit, based on the user command input through the key input unit. Then, the digital signal processing unit processes the AUI sound to output the processed AUI sound.

According to a conventional AUI, sounds already designated by a developer are included in the database, and the sound mapped in advance is output in compliance with feedback according to a key input or a given function or task. Accordingly, as diverse AUIs are provided, the capacity of the AUI database should be increased.

In addition, since the conventional AUI is determined by a developer, AUI sounds may have no correlation with each other. Since the AUI sounds have no correlation with one another, they are mapped irrespective of input keys, functions performed by the electronic device, the importance and frequency of tasks. Accordingly, the respective AUIs are not in mutual organic relations with each other to cause a user to be confused.

Consequently, due to the insignificant AUI, the user cannot predict which function or task is presently being performed when the user hears the AUI only causing utility of the AUI function to decrease.

### SUMMARY OF THE INVENTION

The present general inventive concept provides a user interface method and apparatus which can make respective auditory user interfaces (AUIs) be in mutual organic relations with each other by properly changing a basic melody or sound in accordance with the importance and frequency of a function or task performed by an electronic device according to a user command. Accordingly, a user is enabled to easily predict the type of the task being presently performed when the user hears the AUI only.

Additional aspects and utilities of the present general inventive concept will be set forth in part in the description which follows and, in part, will be obvious from the description, or may be learned by practice of the general inventive concept.

The foregoing and other aspects and utilities are substantially realized by providing a user interface method including determining whether a command for user interface (UI) event occurrence is input, reading a pre-stored auditory user interface (AUI) element if the command for UI event occurrence is input, generating an AUI by changing the AUI element, and outputting the generated AUI to an outside.

The user interface method may further include reading a pre-stored graphical user interface (GUI) element that corresponds to the UI event if the command for UI event occurrence is input is determined, generating a GUI based on the GUI element, and displaying the generated GUI, wherein the displaying of the GUI is performed together with the outputting of the AUI.

The generating of the AUI may include converting a sampling rate of the generated AUI to correspond to a sampling rate of an audio signal being output.

The generating of the AUI may include adjusting a sound length of the AUI element, and an adjustment of the sound length of the AUI element may correspond to an adjustment of an output time of the AUI element.

The generating of the AUI may include adjusting a volume of the AUI element, and an adjustment of the volume of the AUI element may correspond to an adjustment of an amplitude of the AUI element.

The generating of the AUI may include adjusting a sound pitch of the AUI element, and an adjustment of the sound pitch of the AUI element may correspond to an adjustment of a frequency of the AUI element.

The AUI element may be composed of at least one sound or melody.

If the AUI element corresponds to the melody, the AUI may be generated by preventing an output of the at least one sound constituting the melody.

The foregoing and/or other aspects and utilities of the general inventive concept may also be achieved by providing an electronic device including a first storage unit to store an auditory user interface (AUI) element, an AUI generation unit to generate an AUI by changing the AUI element, and a control unit to control the AUI generation unit to generate the AUI that corresponds to a user interface (UI) event if a command for UI event occurrence is input.

The electronic device may further include a second storage unit to store a graphical user interface (GUI) element, and a GUI generation unit to generate a GUI based on the GUI element, wherein the control unit controls the GUI generation unit to generate the GUI that corresponds to the UI event if the command for UI event occurrence is input.

The AUI generation unit may include a sampling rate conversion unit to convert a sampling rate of the generated AUI to correspond to a sampling rate of an audio signal being output.

The AUI generation unit may include a sound length adjustment unit to adjust a sound length of the AUI element, and an adjustment of the sound length of the AUI element may correspond to an adjustment of an output time of the AUI element.

The AUI generation unit may include a volume adjustment unit to adjust a volume of the AUI element, and an adjustment of the volume of the AUI element may correspond to an adjustment of an amplitude of the AUI element.

The AUI generation unit may include a sound pitch adjustment unit to adjust a sound pitch of the AUI element, and an adjustment of the sound pitch of the AUI element may correspond to an adjustment of a frequency of the AUI element.

The AUI element may be composed of at least one sound or melody.

The AUI generation unit may generate the AUI by preventing an output of the at least one sound constituting the melody when the AUI element corresponds to the melody.

The foregoing and/or other aspects and utilities of the general inventive concept may also be achieved by providing a user interface usable with an electronic device, the user interface including an input unit to allow a user to select an input command, and a output unit to output an auditory response corresponding to the selected input command, wherein the auditory response is formed by changing one or more predetermined auditory elements based on at least one of an importance and a frequency of a function to be performed by the electronic device according to the selected input command.

The foregoing and/or other aspects and utilities of the general inventive concept may also be achieved by providing a user interface method including determining an input command selected by a user, forming an auditory response by changing one or more predetermined auditory elements based on at least one of an importance and a frequency of a function to be performed by an electronic device according to the determined input command and outputting the formed auditory response corresponding to the determined input command.

The foregoing and/or other aspects and utilities of the general inventive concept may also be achieved by providing a computer-readable recording medium having embodied thereon a computer program to execute a method, wherein the method includes determining an input command selected by a user, forming an auditory response by changing one or more predetermined auditory elements based on at least one of an importance and a frequency of a function to be performed by an electronic device according to the determined input command, and outputting the formed auditory response corresponding to the determined input command.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating the construction of an MP3 player that is a type of electronic device to which the present general inventive concept can be applied;

FIG. 2 is a flowchart illustrating a method of generating and outputting an AUI and a GUI corresponding to a command for event occurrence according to an embodiment of the present general inventive concept;

FIGS. 3A to 3C are graphs illustrating an AUI element according to an embodiment of the present general inventive concept;

FIGS. 4A to 4D are graphs illustrating an AUI generated based on AUI element according to an embodiment of the present general inventive concept;

FIGS. 5A and 5B are views related to an AUI implemented by a melody according to an embodiment of the present general inventive concept;

FIGS. 6A and 6B are views related to an AUI implemented by a chord according to an embodiment of the present general inventive concept;

FIGS. 7A and 7B are views related to an AUI having the directionality according to an embodiment of the present general inventive concept;

FIG. 8 is a view related to an AUI implemented by a portion of a melody according to an embodiment of the present general inventive concept;

FIGS. 9A and 9B are views related to an AUI provided when respective items that constitute a menu among AUIs for menu navigation are moved;

FIG. 10 is a view related to a GUI indicating an example of a menu;

FIG. 11 is an exemplary view related to an AUI applied to a hierarchical menu structure; and

FIGS. 12A and 12B are views related to another AUI according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

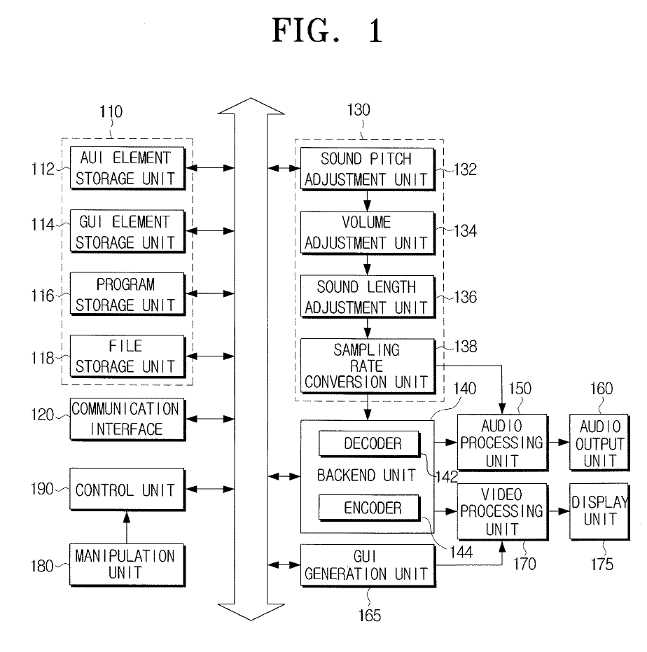

FIG. 1 is a block diagram illustrating a construction of an MP3 player that is a type of electronic device to which the present general inventive concept can be applied.

As illustrated in FIG. 1, the MP3 player includes a storage unit 110, a communication interface 120, an AUI generation unit 130, a backend unit 140, an audio processing unit 150, an audio output unit 160, a GUI generation unit 165, a video processing unit 170, a display unit 175, a manipulation unit 180, and a control unit 190.

The storage unit 110 stores program information required to control the MP3 player, content information, icon information, and files, and includes an AUI element storage unit 112, a GUI element storage unit 114, a program storage unit 116, and a file storage unit 118.

The AUI element storage unit 112 is a storage unit in which basic sounds and basic melodies that are AUI elements to constitute the AUI, and the GUI element storage unit 114 is a storage unit in which content information, icon information, and the like, that are GUI elements to constitute the GUI. The program storage unit 116 stores program information to control function blocks of the MP3 player such as the backend unit 140 and various types of updatable data. The file storage unit 118 is a storage medium to store compressed files output from the communication interface 120 or the backend unit 140. The compressed file stored in the file storage unit 118 may be a still image file, a moving image file, an audio file, and the like.

The communication interface 120 performs data communications with an external device. The communication interface 120 receives files or programs from the external device, and transmits files stored in the file storage unit 118 to the external device.

The AUI generation unit 130 generates an AUI of the MP3 player using AUI elements stored in the AUI element storage unit 112, and includes a sound pitch adjustment unit 132, a volume adjustment unit 134, a sound length adjustment unit 136, and a sampling rate conversion unit 138. The sound pitch adjustment unit 132 generates a sound having a specified pitch by adjusting a sound pitch of the AUI element. The volume adjustment unit 134 adjusts a volume of the sound output from the sound pitch adjustment unit 132. The sound length adjustment unit 136 adjusts the length of the sound output from the volume adjustment unit 134 and applies the length-adjusted sound to the sampling rate conversion unit 138. The sampling rate conversion unit 138 searches for the sampling rate of an audio signal being played, and converts the sampling rate of the sound being output from the sound length adjustment unit 136 into the sampling rate of the audio signal being played to apply the converted audio signal to the audio processing unit 150.

Alternatively, the GUI generation unit 165, under the control of the control unit 190, generates a specified GUI using the GUI element stored in the GUI element storage unit 114, and outputs the generated GUI to the display unit 175, so that a user can view the command input by the user and a state of task performance through the display unit 175.

The backend unit 140 is a device to take charge of a signal process such as compression, expansion, and playback of the video and/or audio signals. The backend unit 140 is briefly provided with a decoder 142 and an encoder 144.

Specifically, the decoder 142 decompresses a file input from the file storage unit 118, and applies audio and video signals to the audio processing unit 150 and the video processing unit 170, respectively. The encoder 144 compresses the video and audio signals input from the interface in a specified format, and transfers the compressed file to the file storage unit 118. The encoder 144 may compress the audio signal input from the audio processing unit 150 in a specified format and transfer the compressed audio file to the file storage unit 118.

The audio processing unit 150 converts an analog audio signal input through an audio input device such as a microphone (not illustrated) into a digital audio signal, and transfers the converted digital audio signal to the backend unit 140. In addition, the audio processing unit 150 converts the digital audio signal output from the backend unit 140 and the AUI applied from the AUI generation unit 130 into analog audio signals, and outputs the converted analog audio signals to the audio output unit 160.

The video processing unit 170 is a device that processes the video signal input from the backend unit 140 and the GUI input from the GUI generation unit 165, and outputs the processed video signals to the display unit 175.

The display unit 175 is a type of display device that displays video, text, icon, and so forth, output from the video processing unit 170. The display unit 175 may be built in the electronic device or may be a separate external output device.

The manipulation unit 180 is a device that receives a user's manipulation command and transfers the received command to the control unit 190. The manipulation unit 180 is implemented by special keys, such as up, down, left, right, and back keys and a selection key, provided on the MP3 player as one body. In addition, the manipulation unit 180 may be implemented by a GUI whereby a user command can be input through a menu being displayed on the display unit 175.

The control unit 190 controls the entire operation of the MP3 player. Particularly, when a user command is input through the manipulation unit 180, the control unit 190 controls several function blocks of the MP3 player to correspond to the input user command. For example, if a user inputs a command to playback a file stored in the file storage unit 118, the control unit 190 controls the AUI element storage unit 112, the AUI generation unit 130, and the audio processing unit 150 so that an AUI that corresponds to the file playback command is output through the audio output unit 160. After the AUI that corresponds to the file playback command is output, the control unit 190 reads the file stored in the file storage unit 118 and applies the read file to the backend unit 140. Then, the backend unit 140 decodes the file, and the audio processing unit 150 and the video processing unit 170 process the decoded audio and video signals to output the processed audio and video signals to the audio output unit 160 and the display unit 175, respectively.

If the user inputs a menu display command through the manipulation unit 180, the control unit 190 controls the AUI element storage unit 112, the AUI generation unit 130, and the audio processing unit 150 so that the AUI that corresponds to the menu display command is output, and controls the GUI element storage unit 114, the GUI generation unit 165, the video processing unit 170, and the display unit 175 so that the GUI that corresponds to the menu display command is output.

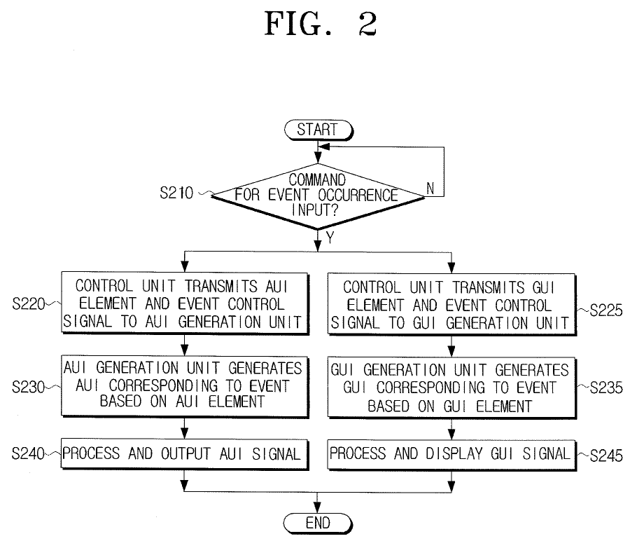

FIG. 2 is a flowchart illustrating a method of generating and outputting an AUI and a GUI corresponding to a command for event occurrence according to an embodiment of the present general inventive concept.

First, the control unit 190 judges whether an event has occurred at operation (S210). Here, the term “event” represents not only a user command input through the manipulation unit 180 but also sources to generate various types of UIs that are provided to the user. The UIs may include information on a connection with an external device through the communication interface 120, power state information of the MP3 player, and so forth. For example, the control unit 190 judges whether a power-on command that is a type of event occurrence is input.

If the command for event occurrence is input is determined (“Y” at operation (S210)), the control unit 190 reads the AUI element stored in the AUI element storage unit 112 to apply the read AUI element to the AUI generation unit 130, and generates a control signal that corresponds to the event to apply the control signal to the AUI generation unit 130 at operation (S220). In addition, the control unit 190 reads the GUI element, that corresponds to the event, stored in the GUI element storage unit 114 to apply the read GUI element to the GUI generation unit 165, and generates a control signal that corresponds to the event to apply the control signal to the GUI generation unit 165 at operation (S225).

The AUI generation unit 130 generates the AUI that corresponds to the event based on the AUI element at operation (S230). A method of generating the AUI through the AUI generation unit 130 will be described later. In addition, the GUI generation unit 165 generates the GUI that corresponds to the event based on the GUI element at operation (S235).

The generated AUI is output to the output unit 160 through the audio processing unit at operation (S240), and the generated GUI is output to the display unit 175 through the video processing unit 170 at operation (S245). For the sake of user convenience, the GUI can be output simultaneously with the AUI.

Thereafter, a process of generating a specified AUI based on the AUI element that is performed by the AUI generation unit 130 will be described in detail.

The AUI element is briefly composed of pitch information, volume information and sound length information. The pitch information is related to a frequency of a sound, the volume information is related to an amplitude of the sound, and the sound length information is related to an output time of the sound. For convenience' sake, the AUI element is defined as ƒ(t)=A₀ sin(w₀t){U(t)−U(t−T₀)}. Here, U(t) is a step function. Accordingly, the AUI element has a pitch of f₀=w₀/2π, an amplitude of A₀, and an output time of T₀. In particular, the output time of the AUI element corresponds to a period from 0 to T₀.

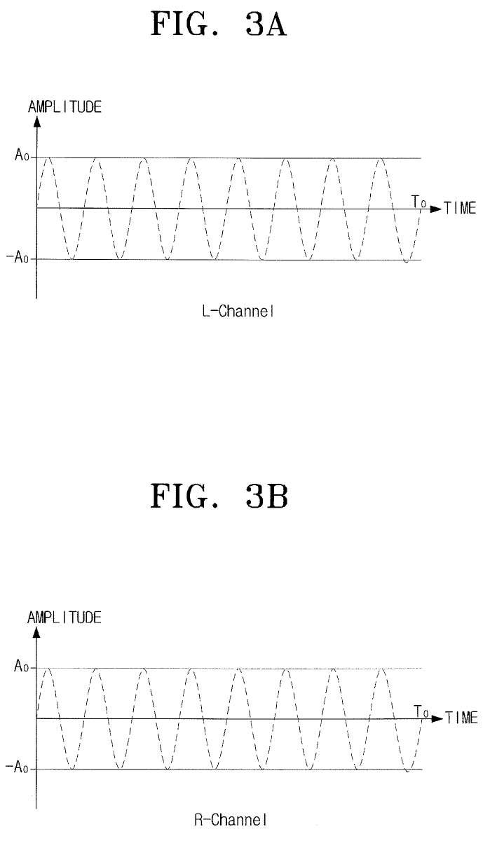

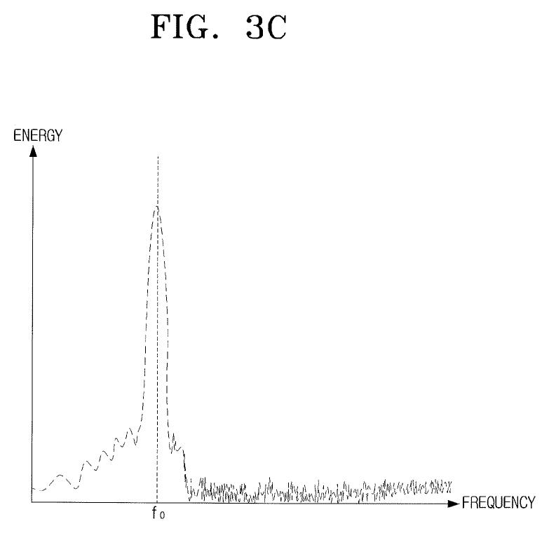

FIGS. 2 and 3A to 3C are graphs illustrating an AUI element according to an embodiment of the present general inventive concept. FIGS. 3A and 3B are graphs illustrating an AUI element in a time domain. FIG. 3A illustrates an AUI element output from a left channel (not illustrated) of the audio output unit 160, and FIG. 3B illustrates an AUI element output from a right channel (not illustrated) of the audio output unit 160. As illustrated in FIGS. 3A and 3B, the volume information of the AUI element, i.e., the amplitude, is A₀, and the sound length information, i.e., the sound output time, is T₀. FIG. 3C is a graph illustrating an AUI element in a frequency domain. The pitch information of the AUI element, i.e., the frequency, is f₀=w₀/2π.

The AUI element as described above is converted into a specified sound by the AUI generation unit 130 under the control of the control unit 190. For example, the sound pitch adjustment unit 132 converts the input frequency f₀ that is the pitch information of the AUI element into a frequency f′. In order to convert the frequency, the sound pitch adjustment unit 132 converts the AUI element in a time domain into an AUI element in a frequency domain using an FFT transform, and then substitutes an energy value of the frequency f′ for an energy value of the frequency f₀ having an important energy component among FFT-transformed components.

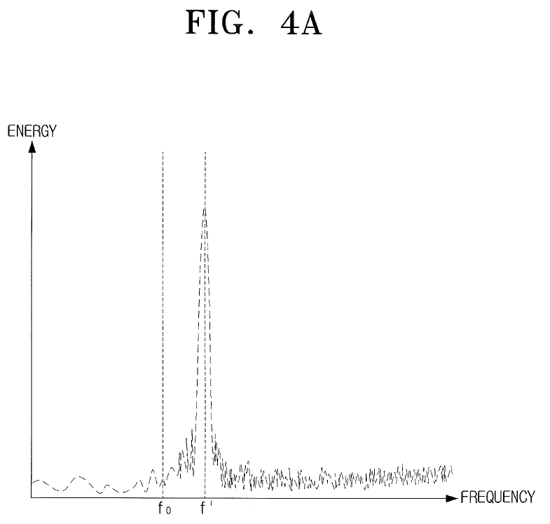

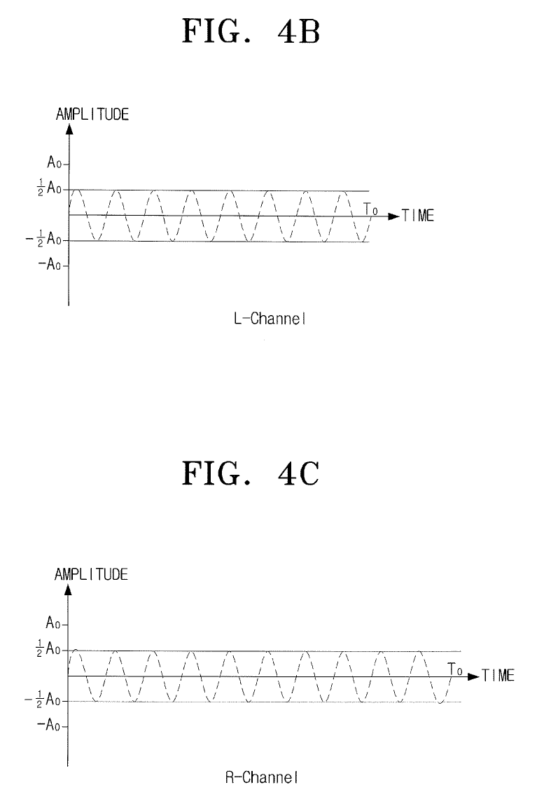

FIG. 4A is a graph illustrating the frequency f′, which has been transformed from the frequency f₀ through the sound pitch adjustment unit 132 (FIG. 2), in a frequency domain. In an exemplary embodiment of the present general inventive concept, the AUI element is FFT-transformed by the sound pitch adjustment unit 132 so that the pitch information can be converted more easily in a frequency domain, as illustrated in FIG. 3C. However, since the volume information and the sound length information can be easily converted in a time domain, the sound pitch adjustment unit 132 performs an IFFT transform of the FFT-transformed AUI element.

Alternatively, referring to FIGS. 2, 4B to 4D, the volume adjustment unit 134 adjusts the volume information of the AUI element. The term “volume” represents an amount of sound being output through the audio output unit 160, and can be adjusted by changing the amplitude of the sound. FIGS. 4B and 4C are graphs illustrating the volume information adjusted by the volume adjustment unit 134 in a time domain. As illustrated in FIGS. 4B and 4C, the adjusted sound has a magnitude of −6 dB in comparison to the AUI element.

The sound length adjustment unit 136 changes the output time of the AUI element. That is, the sound length adjustment unit 136 repeatedly outputs a specified sound in accordance with a control signal of the control unit 190. FIG. 4D is a graph illustrating the sound length information adjusted by the sound length adjustment unit 136 in a time domain. As illustrated in FIG. 4D, the changed sound is output for a time T′.

Accordingly, the sound generated by the AUI generation unit 130 becomes ƒ′(t)=A′ sin(w′t){U(t)−U(t−T′)}. That is, even if only one AUI element exists, the AUI generation unit 130 can generate a new sound. Since the generated sound is related to the AUI element, the generated sound can provide familiarity with the user in comparison to the individually stored AUI. In addition, the AUI element storage unit 112 does not have to have a large storage capacity. Thus, the electronic device can be miniaturized.

The sampling rate conversion unit 138 converts the sampling rate of the changed sound to match the sampling rate set by the audio processing unit 150. The sampling rates set by the audio processing unit 150 may differ depending on characteristics of the files. Accordingly, in order to generate the AUI during the playback of the file requires changing the sampling rate.

In the embodiment of the present general inventive concept, one sound is generated using one AUI element. However, the present general inventive concept is not limited thereto, and generating melodies or a chord using one AUI element is also within the scope of the present general inventive concept.

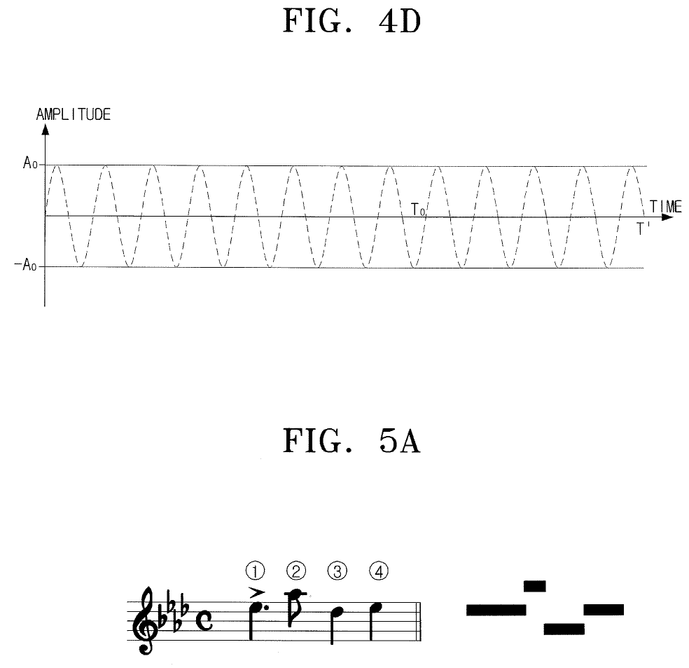

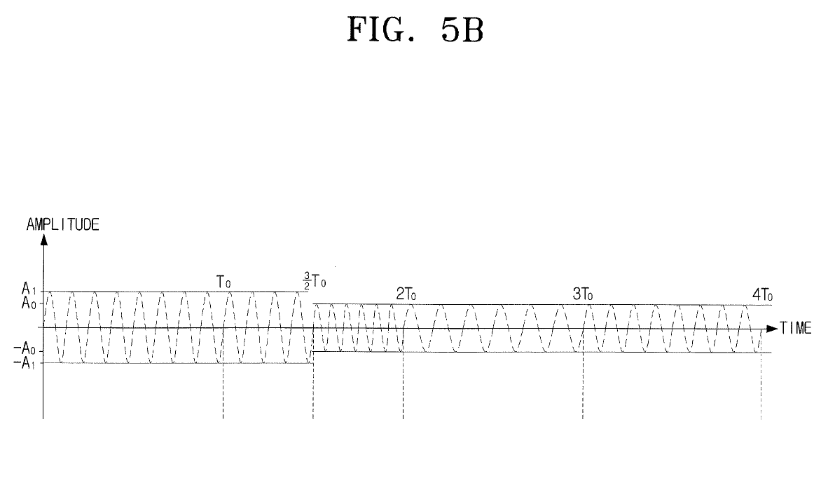

FIG. 5A illustrates an AUI provided by the electronic device when power is turned on. Referring to FIGS. 2 and FIG. 5A, the AUI provided by the electronic device when the power is turned on is a melody composed of four sounds. Assuming that the fourth sound corresponds to the AUI element, the volume adjustment unit 134 and the sound length adjustment unit 136 changes the AUI element in order to generate the first sound, which is ƒ₁(t)=A₁ sin(w₀t){U(t)−U(t−1.5×T₀)}. The first sound has a large amplitude and a long output time in comparison to the AUI element.

Then, the sound pitch adjustment unit 132 changes the frequency of the AUI element, and the sound length adjustment unit 136 changes the output time of the AUI element, so that the second sound, which is ƒ₂(t)=A sin(w₂t){U(t−1.5×T₀)−U(t−2×T₀)}, is generated. Here, w₂ is larger than w₀. Also, since the melody is to be generated using the AUI element, the sound length adjustment unit 136 sets the time from 1.5×T₀, which is the output end time of the first sound, to 2×T₀, as the output time of the second sound, in order to make the second sound be output after the first sound is output.

In the same manner, the AUI generation unit 130 generates the third sound, ƒ₃(t)=A₀ sin(w₃t){U(t−2×T₀)−U(t−3×T₀)}, and the fourth sound, ƒ₄(t)=A₀ sin(w₀t){U(t−3×T₀)−U(t−4×T₀)}, to output the third and fourth sounds to the audio processing unit 150. The audio processing unit 150 converts the input sounds into analog audio signals to output the converted analog audio signals to the audio output unit, and the audio output unit outputs a melody as illustrated in FIG. 5A.

FIG. 5B is a graph illustrating a melody generated by the AUI generation unit 130 (FIG. 2) in a time domain. Referring to FIGS. 2 and 5B, melodies being output from a left channel and a right channel of the audio output unit are the same.

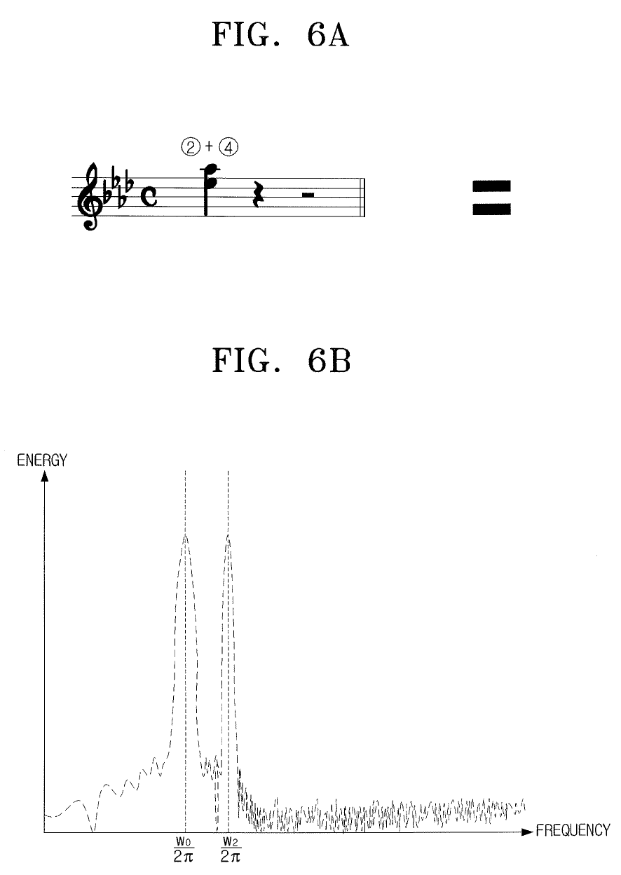

Alternatively, the AUI generation unit 130 can generate a chord. FIG. 6A illustrates a chord according to an embodiment of the present general inventive concept. Referring to FIGS. 2 and 6A, in order to generate the chord, the AUI generation unit 130 generates a fifth sound, ƒ₅(t)=A₀ sin(w₀t){U(t)−U(t−T₀)}. In practice, the fifth sound is equal to the AUI element. Accordingly, the AUI generation unit 130 outputs the AUI element stored in the AUI element storage unit 112 without any change. Then, the AUI generation unit 130 generates a sixth sound, f₆(t)=A₀ sin(w₂t){U(t)−U(t−T₀)}, based on the AUI element. Since the output time of the fifth sound is the same as the output time of the sixth sound, the sound being output from the audio output unit becomes the chord. FIG. 6B is a graph illustrating the chord generated by the AUI generation unit 130 in a frequency domain.

In addition, in order to create an effect of menu movement, a sound effect that the output sound is moved from left to right may be provided. For this, the volume of the sound that is output through the left channel of the audio output unit and the volume of the sound that is output through the right channel of the audio output unit are properly adjusted.

For example, by gradually increasing the volume of the sound being output through the right channel while gradually decreasing the volume of the sound being output through the left channel, the user can feel the effect of menu movement through the respective sound.

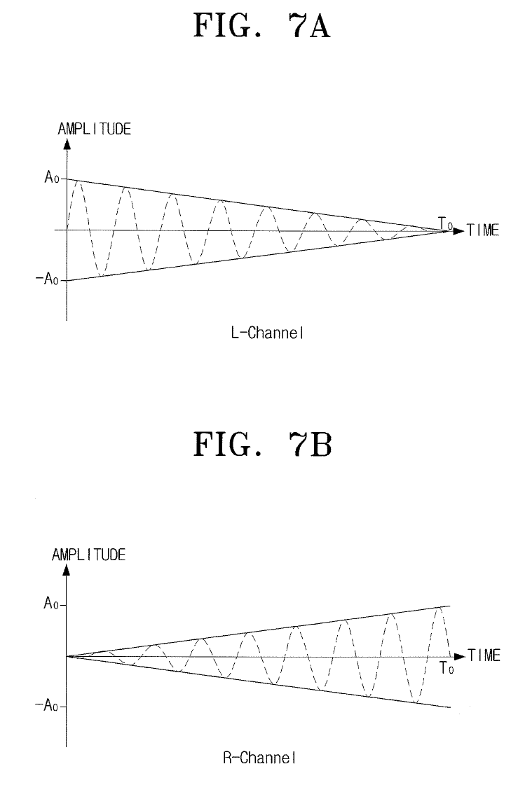

Specifically, in order to output the AUI having directionality, the AUI generation unit 130 generates ƒ_{L}(t)=A₀(1−t/T₀)sin(w₂t){U(t)−U(t−T₀)} that is the sound being output through the left channel, and generates ƒ_{R}(t)=(A₀/T₀)t sin(w₂t){U(t)−U(t−T₀)} that is the sound being output through the right channel of the audio output unit. FIGS. 7A and 7B are graphs illustrating the sounds having the directionality in a time domain.

The volume adjustment of the sounds being output through the left and right channels of the audio output unit may be performed in the other way. Accordingly, a sound effect that the output sound is moved from right to left can be obtained.

In the present embodiment, various types of AUIs are generated using one AUI element that is the basic sound. However, the present general inventive concept is not limited thereto, and a plurality of sounds may be used as the AUI elements. Accordingly, the AUI generation unit 130, under the control of the control unit 190, can generate a specified AUI using one or more AUI elements.

In addition, the AUI element may be a melody. In practice, using the melody as the AUI, the AUI can be generated by storing the melody as the AUI element and outputting the entire melody or a portion of the melody only.

Hereinafter, a method of setting the AUI provided when the power is turned on as the AUI element and generating the AUI according to another event will be described.

Typically, the electronic device immediately reacts when the electronic device is first turned on. For this, the basic melody data stored in the AUI element storage unit 112 should be output without any change to give the fastest sound feedback.

Also, the sound output time of the AUI provided when the power is turned on should be set not to be longer than the initial screen or the system loading time (i.e., booting time) of the electronic device.

In an exemplary embodiment, the user can be informed to input another command after the completion of the booting time. Since the user typically recognizes that no command should be input during the generation of the AUI, the AUI providing time is determined not to be longer than the system loading time or booting time.

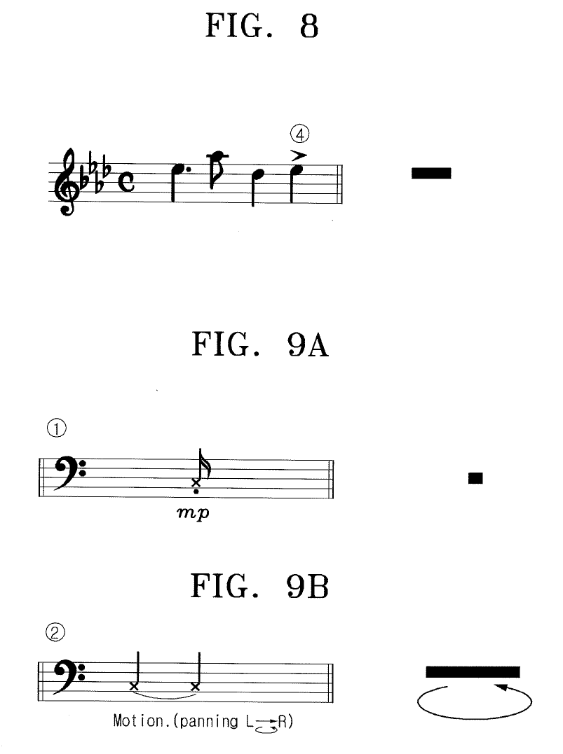

FIG. 8 illustrates the AUI that corresponds to the power off. When the power is turned off, a feedback faster then when the power is turned on is required, and thus only a portion of the basic melody is used. In the embodiment of the present general inventive concept, the AUI at the power off is provided using only the fourth sound.

FIGS. 9A and 9B are views related to an AUI provided when respective items that constitute a menu among AUIs for menu navigation are moved. During the menu navigation, a menu movement frequently occurs, and thus a rapid feedback is required. Accordingly, to help rapid performing of a task in consideration of repeated use and to rapidly feed information about the proceeding back to the user, the AUI used at that time can be simple and non-melodic. In the present embodiment, a short sound without melody can be output.

FIG. 9B illustrates the AUI having directionality. As described above, in order to create an effect of menu movement, a sound effect that the output sound is moved from left to right is provided.

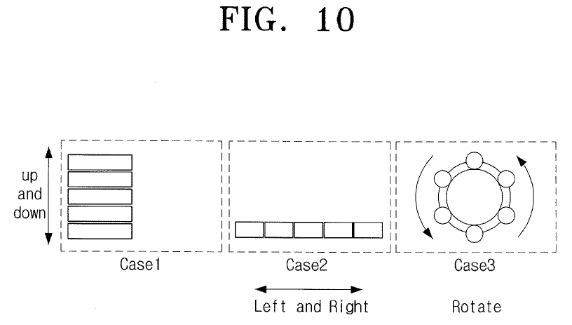

FIG. 10 is a view related to a GUI indicating an example of a menu. The electronic device can output the AUI as described above together with the GUI that indicates the movement of the respective items that constitute the menu.

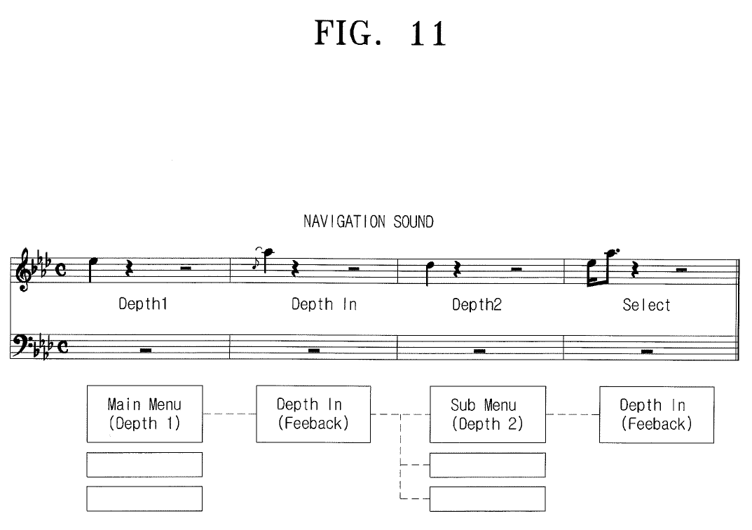

FIG. 11 is an exemplary view related to an AUI applied to a hierarchical menu structure.

The hierarchical menu structure includes an upper level and a lower level, and the respective levels are denoted as depth 1 and depth 2.

The AUI for the depth 1 menu uses a portion of the sounds constituting the basic melody that is the AUI element. In the present embodiment, the very first sound of the basic melody, which is used when the power is turned on, is used as the AUI for the depth 1. The movement between the items in the depth 1 is performed using the AUI as illustrated in FIG. 9A.

If an item is selected in the depth 1 menu, the AUI is provided using the second sound among the sounds constituting the basic melody in order to inform the user that the item has been selected.

If the menu level is changed from the depth 1 to the depth 2, the AUI is provided using the third sound among the sounds constituting the basic melody.

In the same manner, if the menu item is moved in the depth 2 menu, the AUI as illustrated in FIG. 9A is used. If an item is selected in the depth 2 menu, the AUI is provided using the fourth sound among the sounds constituting the basic melody.

As described above, if a movement between menu layers, i.e., between the respective depths, is performed in the hierarchical menu structure, the AUI for the menu depth movement is provided by successively using a portion of the basic melody.

Alternatively, the chord of FIG. 6A as described above can be used as the sound feedback used when a key for select, play, done, or confirm is input. Since an affirmative confirmation feedback should be provided with respect to the above-described key input, a chord composed of the second sound and the fourth sound among the sounds constituting the basic melody is used. By providing the feedback using the chord, the user can feel comfortable and an affirmative atmosphere.

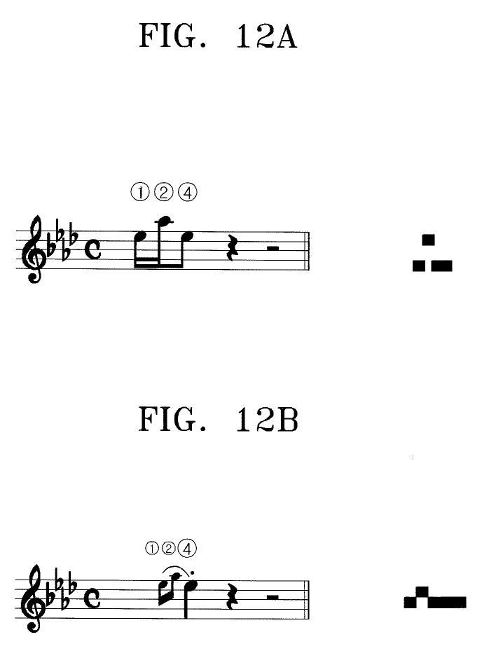

FIGS. 12A and 12B are views related to a key having an opposite concept to the key as illustrated in FIG. 6A. This key may be a key for cancel, back, pause, or stop, and in order to be in correlation with the AUI concept as illustrated in FIGS. 12A and 12B, the AUI is provided using a portion of the basic melody. In the present embodiment, a short rhythm that is obtained by deleting the third sound of the basic melody is used.

In the present embodiment, since the AUI is generated using several basic sounds or basic melodies, the AUIs are in mutual relations with each other, and thus the user convenience can be sought.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, according to various embodiments of the present general inventive concept, an AUI environment using sound information is given to a user, separately from the conventional GUI, and thus the user can be guided to efficiently achieve a given task and reducing errors.

In addition, since a small number of AUI elements is required in executing the AUI, the memory capacity can be reduced.

Although various embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A user interface method, comprising:
determining whether a command for user interface (UI) event occurrence is input;
reading a pre-stored auditory user interface (AUI) element if the command for UI event occurrence is input;
generating an AUI by changing the AUI element; and
outputting the generated AUI to an outside.

2. The user interface method of claim 1, further comprising:
reading a pre-stored graphical user interface (GUI) element that corresponds to the UI event if the command for UI event occurrence is input is determined;
generating a GUI based on the GUI element; and
displaying the generated GUI;
wherein the displaying of the GUI is performed together with the outputting of the AUI.

3. The user interface method of claim 1, wherein the generating of the AUI comprises:
converting a sampling rate of the generated AUI to correspond to a sampling rate of an audio signal being output.

4. The user interface method of claim 1, wherein the generating of the AUI comprises:
adjusting a sound length of the AUI element;
wherein an adjustment of the sound length of the AUI element corresponds to an adjustment of an output time of the AUI element.

5. The user interface method of claim 1, wherein the generating of the AUI comprises:
adjusting a volume of the AUI element;
wherein an adjustment of the volume of the AUI element corresponds to an adjustment of an amplitude of the AUI element.

6. The user interface method of claim 1, wherein the generating of the AUI comprises:
adjusting a sound pitch of the AUI element,
wherein an adjustment of the sound pitch of the AUI element corresponds to an adjustment of a frequency of the AUI element.

7. The user interface method of claim 1, wherein the AUI element is composed of at least one sound or melody.

8. The user interface method of claim 7, wherein if the AUI element corresponds to the melody, the AUI is generated by preventing an output of the at least one sound constituting the melody.

9. An electronic device, comprising:
a first storage unit to store an auditory user interface (AUI) element;
an AUI generation unit to generate an AUI by changing the AUI element; and
a control unit to control the AUI generation unit to generate the AUI that corresponds to a user interface (UI) event if a command for UI event occurrence is input.

10. The electronic device of claim 9, further comprising:
a second storage unit to store a graphical user interface (GUI) element; and
a GUI generation unit to generate a GUI based on the GUI element,
wherein the control unit controls the GUI generation unit to generate the GUI that corresponds to the UI event if the command for UI event occurrence is input.

11. The electronic device of claim 9, wherein the AUI generation unit comprises:
a sampling rate conversion unit to convert a sampling rate of the generated AUI to correspond to a sampling rate of an audio signal being output.

12. The electronic device of claim 9, wherein the AUI generation unit comprises:
a sound length adjustment unit to adjust a sound length of the AUI element,
wherein an adjustment of the sound length of the AUI element corresponds to an adjustment of an output time of the AUI element.

13. The electronic device of claim 9, wherein the AUI generation unit comprises:
a volume adjustment unit to adjust a volume of the AUI element,
wherein an adjustment of the volume of the AUI element corresponds to an adjustment of an amplitude of the AUI element.

14. The electronic device of claim 9, wherein the AUI generation unit comprises:
a sound pitch adjustment unit to adjust a sound pitch of the AUI element,
wherein an adjustment of the sound pitch of the AUI element corresponds to an adjustment of a frequency of the AUI element.

15. The electronic device of claim 9, wherein the AUI element is composed of at least one sound or melody.

16. The electronic device of claim 15, wherein the AUI generation unit generates the AUI by preventing an output of the at least one sound constituting the melody when the AUI element corresponds to the melody.

17. A user interface usable with an electronic device, the user interface comprising:
an input unit to allow a user to select an input command; and
an output unit to output an auditory response corresponding to the selected input command,
wherein the auditory response is formed by changing one or more predetermined auditory elements based on at least one of an importance and a frequency of a function to be performed by the electronic device according to the selected input command.

18. The user interface of claim 17, wherein the one or more predetermined auditory elements is changed by adjusting at least one of a sound pitch thereof, a volume thereof, a sound length thereof and a sound sampling rate thereof.

19. The user interface of claim 17, wherein the auditory response creates a perception of directionality to the user.

20. A user interface method, comprising:
determining an input command selected by a user;
forming an auditory response by changing one or more predetermined auditory elements based on at least one of an importance and a frequency of a function to be performed by an electronic device according to the determined input command; and
outputting the formed auditory response corresponding to the determined input command.

21. A computer-readable recording medium having embodied thereon a computer program to execute a method, wherein the method comprises:
determining an input command selected by a user;
forming an auditory response by changing one or more predetermined auditory elements based on at least one of an importance and a frequency of a function to be performed by an electronic device according to the determined input command; and
outputting the formed auditory response corresponding to the determined input command.
